(19) United States
(12) Patent Application Publication
(10) Pub. No.: US 2008/0021801 A1
(43) Pub. Date: Jan. 24, 2008

(54) Dynamic multidimensional risk-weighted suspicious activities detector

(76) Inventors: Yuh-shen Song, Northridge, CA (US); Catherine Lew, Northridge, CA (US); Alexander Song, Northridge, CA (US); Victoria Song, Northridge, CA (US)

Correspondence Address: FULBRIGHT AND JAWORSKI LLP, 555 S. FLOWER STREET, 41ST FLOOR, LOS ANGELES, CA, 90071, US

(21) Appl. No.: 11/254,077

(22) Filed: Oct. 18, 2005

Related U.S. Application Data
(60) Provisional application No. 60/685,651, filed on May 31, 2005.

(51) Int. Cl. G06Q 40/00

(52) U.S. Cl. 705/35

(57) ABSTRACT

A computerized method is established to detect suspicious and fraudulent activities in a group of subjects by defining and dynamically integrating multidimensional risks, which are based on the characteristics of the subjects, into a mathematical model to produce a set of the most up-to-date representative risk values for each subject based on its activities and background. These multidimensional risk definitions and representative risk values are used to select a subset of multidimensional risk-weighted detection algorithms so that suspicious or fraudulent activities in the group of subjects can be effectively detected with higher resolution and accuracy. A priority sequence, which is based on the set of detection algorithms that detect the subject and the representative risk values of the detected subject, is produced to determine the priority of each detected case during the investigation process. To assist the user to make a more objective decision, any set of multidimensional risks can be used to identify a group of subjects that contain this set of multidimensional risks so that group statistics can be obtained for comparison and other analytical purposes. Furthermore, to fine-tune the system for future detections and analyses, the detection results are used as the feedback to adjust the definitions of the multidimensional risks and their values, the mathematical model, and the multidimensional risk-weighted detection algorithms.

### CROSS REFERENCE TO RELATED APPLICATIONS

This application claims priority of U.S. provisional patent application No. 60/685,651 filed on May 31, 2005, which is hereby incorporated in this application.

### FIELD OF INVENTION

The present invention relates generally to computer assisted technology for detecting suspicious and fraudulent activities. More specifically, an exemplary embodiment of the present invention dynamically associates different risk values to different subjects, so that certain suspicious and fraudulent activities associated with those subjects can be automatically detected with higher resolution and accuracy.

### BACKGROUND OF THE INVENTION

Many organizations have the need to detect suspicious activities. For example, a company needs to detect any of its employees who may have stolen a trade secret from the company. An immigration office needs to detect any alien who may be related to any illegal activities. A financial institution needs to detect any fraud, which can cause losses and damages to the financial institution.

In fact, all financial institutions in the USA are required by law to detect and report any suspicious activity to Financial Crimes Enforcement Network (“FinCEN”). For the purpose of explanation, we will use the regulatory requirement for banks to detect suspicious activities as an example in this document. However, in addition to helping banks detect suspicious activities, other embodiments of the present invention can also be used for many other applications.

Banks are required to monitor their clients' transactions and behaviors in order to report any suspicious activity. In addition, banks are required to identify and closely monitor their high-risk clients. These two requirements are actually related because high-risk clients are often the instigators of, or are otherwise directly associated with, reportable suspicious activities.

To meet these regulatory requirements, a bank will typically purchase a computer software package, which will produce a set of reports based on the criteria set by the bank. For example, pawnshops are typically classified as high-risk clients, which can become the channels for money laundering. A bank has to identify which clients are in the pawnshop business and then a report can be produced to list these pawnshop clients. With this list of pawnshops, the bank can further study the activities of these pawnshops to determine whether they have any suspicious activities. However, this commonly used approach often causes many problems.

First, risks are multidimensional by nature. For example, in terms of money laundering activities, a client who often sends wire transfers to foreign countries may represent a high risk. A client who often withdraws a large amount of cash from the Automated Teller Machine (“ATM”) may represent a high risk. A client who operates as a money services business may represent a high risk. A client who often conducts a large amount of ACH transactions may represent a high risk. A client who is a non-resident alien may represent a high risk. In general, there are many different factors for a bank to consider in order to determine whether a client falls into the high-risk client category. It is a complicated decision involving multidimensional risks.

Secondly, even high-risk clients may have different risk exposures. Some risk dimensions have greater risk exposure than others. For example, in terms of terrorist financing activities, sending wire transfers to Iraq may imply a higher risk exposure than withdrawing money frequently from an ATM terminal. Moreover, a client may have more than one risk exposure, which all contribute to the risk profile for that particular client. One client, who conducts money services and also frequently sends wire transfers to Cuba may represent a much higher risk exposure than another client, who only conducts money services with no wire transfer activities. As a result, each high-risk client may represent a different risk profile to the bank.

Thirdly, there are too many possible combinations of multidimensional risks for a bank to monitor each such risk profile manually. Assuming that a bank has identified 100 risk dimensions, the number of possible combinations of these 100 risk dimensions is 2 to the power of 100. There is no way for the bank to identify all the possible risk profiles based on a manual process.

Fourthly, clients are constantly changing their transactional and behavioral patterns. Given time, a client initially considered to be low risk may soon become a high-risk client and a high-risk client may soon become a lower risk client. In other words, a bank has to constantly determine and update who the “current” high-risk clients are in the bank.

Fifthly, there are too many clients who may be classified as ‘high-risk clients.’ For example, many banks are recommended to use the ‘5% rule’ as one of the criteria to identify high-risk clients. ‘5% rule’ means that a bank has to monitor the top five percent clients who are heavy in cash activities, top five percent in wire transfer activities, top five percent in ATM activities, top five percent in check activities, etc. Even for a small bank with about only 10,000 clients, 5% means 500 clients. In other words, a bank has to monitor on a daily basis 500 clients who are heavy in cash activities, 500 in wire transfer activities, 500 in check activities, 500 in ATM activities, etc. It is easy to print reports to indicate who these 500 clients are in each category. The difficulty is how to read through these large reports and investigate the related activities of each individual high-risk client on a daily basis.

Sixthly, even after identifying the high-risk clients, it is still a difficult task to monitor and detect suspicious activities conducted by these high-risk clients. There are many different behavioral patterns, transactional patterns, historical patterns and other patterns that should be treated as an indicator of possible suspicious activities. The Bank Secrecy Act (“BSA”) Officer, Security Officer and related personnel inside the bank have to read a large number of reports listing different activities in order to identify any suspicious activities. A huge amount of human effort is required to perform such tasks.

Seventhly, high-risk clients are not the only clients who may conduct suspicious activities. Low risk clients may also take part in suspicious activities. Therefore, a bank still needs to monitor lower risk clients although they have less risk exposure than the high-risk clients, who are of primary concern for the bank to monitor.

Eighthly, to further complicate matters, a bank is required by law to monitor a group of related clients for anything suspicious. For example, co-signers are a group of related clients. Co-borrowers are a group of related clients. People living together are a group of related clients. There are many different relationships, which a bank should know about and monitor in order to detect and report any suspicious activity as required by law. Each relationship may generate yet another report for the bank to review.

As a result, to meet all these complicated regulatory requirements, a bank has to print a large number of different reports based on different criteria. Many people in the bank have to read these reports in order to monitor, detect, investigate and report suspicious activities.

Based on this commonly used approach, after purchasing a software package, many banks have to constantly hire people to handle this regulatory requirement of reporting suspicious activities. Even with a large group of employees, a bank will still encounter many troubles because it is extremely difficult to coordinate a group of people to efficiently identify suspicious activity.

The US government requires financial institutions to file a Suspicious Activity Report (“SAR”) with FinCEN if any person or organization has any suspicious activity, which is detected by the financial institutions. There are about 20 categories of suspicious activities on the SAR form, which financial institutions are supposed to report, including money laundering, terrorist financing, check fraud, credit card fraud, loan fraud, self-dealing, etc.

Although we will use the US regulatory requirement for banks to file SARs as an example in this document, other embodiments of the present invention can be applied to detecting other fraudulent or suspicious activities.

‘Risk’ is an abstract term; however, risk can be quantified mathematically as a risk value which represents the degree of risk exposure. Conventionally, the larger the value is, the more risk the bank is exposed to.

In this document, “multidimensional risks” are generally referred to as many dimensions of risks, each of which may have a fundamentally different (but not necessarily mathematically independent) risk exposure from others. For example, “sending money to Iraq” and “sending money to Cuba” have two different risk exposures and should be represented by two different risk dimensions, although they both fall into the same risk category of “sending wire transfers.

Since each bank is different from others, every bank may have its own policy of how to assign a risk value to a specific risk. For example, sending wire transfers to Iraq may have a risk value of 6 in one bank, but a risk value of 10 in another bank. Instead of enforcing a fixed policy in both banks, a risk dimension such as “sending wire transfers to Iraq” is established and a bank can assign a risk value to this risk dimension based on its own internal policy.

In this document, the terminology “network” or “networks” generally refers to a communication network or networks, which can be wireless or wired, private or public, or a combination of them, and includes the well-known Internet.

In this document, the terminology “computer system” generally refers to either one computer or a group of computers, which may work alone or work together to reach the purposes of the system.

In this document, a “bank” or “financial institution” is generally referred to as a financial service provider, either a bank or a non-bank, where financial services are provided.

In this document, a “bank account” or “financial account” is generally referred to as an account in a financial institution, either a bank or a non-bank, where financial transactions are conducted through payment instruments such as cash, checks, credit cards, debit cards, electronic fund transfers, etc.

### SUMMARY OF THE INVENTION

One objective of certain embodiments of the present invention is to help financial institutions integrate multidimensional risks for detecting and reporting suspicious activities to the government agencies. Another objective is to help financial institutions comply with regulatory requirements through an easy-to-use process without the need to employ a large group of people to read all kinds of reports. Yet another objective is to identify any suspicious or fraudulent activity involving a particular organization so that the organization can take actions in advance to prevent negative impacts caused by the suspicious or fraudulent activity.

The present invention preferably uses one or more “Risk Templates,” with each Risk Template being associated with a respective category of multidimensional risks and the same Risk Template being used to assign risk values for all the risks within that category. These assigned risk values may then be applied to each of the clients of a bank (or other “Subjects” whose activities are being monitored) based on the characteristics of the Subject.

These Risk Templates for all the risk categories are preferably used to produce a set of filled in templates, each one including the assigned risk value for a respective risk dimension, which collectively form a “Set of Multidimensional Risk Definitions.”

A set of risk values (a “Risk Profile”) may be assigned to each of the Subjects based on the characteristics of the Subject, preferably using the Set of Multidimensional Risk Definitions and a computer program which uses the definitions of these multidimensional risks and their values to assign a Risk Profile to each of the Subjects based on the characteristics of the Subject.

A Risk Profile comprising many multidimensional risk values is preferably reduced in accordance with a predetermined mathematical formula (a “Mathematical Model”) into a smaller set of easy-to-manage “Representative Risk Values.” In one practical example, the mathematical formula may produce only one representative risk value for each Subject, which can be intuitively understood and applied.

In one embodiment, the user establishes a set of Detection Algorithms, which have incorporated the Representative Risk Values to increase the resolution of the detection and thus the accuracy of the detection result. Based on the Representative Risk Values of each subject, a different set of Detection Algorithms may be applied to the subject.

In one embodiment of the present invention, transactions associated with Subjects having a higher Representative Risk Value are screened with a wider range of detection, while those transactions associated only with Subjects having a lesser Representative Risk Value are screened with a narrower range of detection.

In other embodiments of the present invention, some Detection Algorithms can be applied specifically to those Subjects who have a particular Risk Profile.

In yet another embodiment of the present invention, each of the detection algorithms is assigned a “Priority Value” and a Subject can be detected by multiple detection algorithms with multiple “Priority Values.” These “Priority Values” of all the Detection Algorithms that detect a Subject are used together with the Representative Risk Value of the detected Subject to form a decision vector, which is used to determine whether this Subject's activities should be investigated at a higher priority than other Subjects' activities.

Furthermore, the detected patterns associated with a specific Subject may be compared with the statistical patterns of a group of Subjects with the same Risk Profile (or certain risk dimensions of that Risk Profile), and the result of that comparison may be used to determine whether the detection result is accurate, which result can further be used to refine the Multidimensional Risk Definitions, Risk Values, Risk Modeling, and the Risk-Weighted Detection Algorithms.

### BRIEF DESCRIPTION OF THE FIGURES

FIG. 1 is an exemplary system diagram showing how multidimensional risk modeling, detection algorithms, and subjects' data may be integrated together to detect suspicious and fraudulent activities of the subjects.

FIG. 2 is an exemplary flow chart showing how the system of FIG. I may be programmed to perform the detection of suspicious and fraudulent activities of a group of subjects step by step.

FIG. 3 is an exemplary set of Multidimensional Risk Templates, which may be used in the system of FIG. I to define multidimensional risks in banks for detecting money-laundering activities.

FIG. 4 is an exemplary risk model, which uses the multidimensional risks defined by the Multidimensional Risk Templates in FIG. 3 to produce a representative risk value of one subject based on a simple mathematical model, which is established through one mathematical operator: addition.

FIG. 5 is an exemplary Multidimensional Risk-Weighted Detection Algorithm, which is based on the set of representative risk values produced by the mathematical model in FIG. 4.

FIG. 6 is an exemplary computer screen display of representative Multidimensional Risk Templates, which financial institutions may copy, fill in, and use in accordance with the requirements of the Bank Secrecy Act.

FIG. 7 is an exemplary computer screen display of which shows how the Multidimensional Risk Templates may be copied and completed by a particular financial institution to define Dynamic Risk Modeling, for that financial institution to use to establish a set of Multidimensional Risk Scores for each of its customers.

FIG. 8 is an exemplary computer screen display which shows the result of Dynamic Risk Modeling for one customer of a financial institution.

FIG. 9 is an exemplary computer screen display, which shows how Dynamic Multidimensional Risk-Weighted Suspicious Activities Detection may be applied to selected customers and selected transactions to generate a SAR Review Report, which financial institutions may use to generate Suspicious Activities Reports in accordance with the requirements of the Bank Secrecy Act.

### DETAILED DESCRIPTION OF CERTAIN PREFERRED EMBODIMENTS AND COMBINATIONS OF EMBODIMENTS

The present invention potentially includes a number of embodiments to provide maximum flexibility in order to satisfy many different needs of both sophisticated and unsophisticated users. Accordingly, we will describe in detail only a few examples of certain preferred embodiments of the present invention and combinations of these embodiments

In this exemplary embodiment, in order to detect the suspicious and fraudulent activities of a group of subjects, the subjects' background and activities data are first input into a database.

Risks are multidimensional by nature. The first step to managing risks is to integrate multidimensional risks into an easy-to-manage set of risk values.

To reach that purpose, in one embodiment of the present invention, the user assigns a risk value to each of the risk dimensions one by one.

In another embodiment of the present invention, the user uses a risk template to produce a set of risk dimensions and assigns a risk value to each of the risk dimensions.

In yet another embodiment of the present invention, the user uses a set of risk templates to produce multiple sets of risk dimensions and assigns a risk value to each of the risk dimensions.

For example, to make it easy for the bank, a risk template is preferably created for the risk category of “sending wire transfers to X (country).” A bank can fill in the country name X and assign a risk value for each different country. As a result, a single risk template of “sending wire transfers,” can be used to generate multiple risk dimensions within that category and to assign a risk value to each risk dimension in the risk category of “sending wire transfers.”

Each subject may have a set of applicable risk values (i.e., an individual risk profile), which are different from others, depending on the subject's activities and background. Since a subject's activities and background may change from time to time, the risk dimensions and values of a subject have to be updated dynamically to reflect the current risk exposure of the subject from a multidimensional risk point of view.

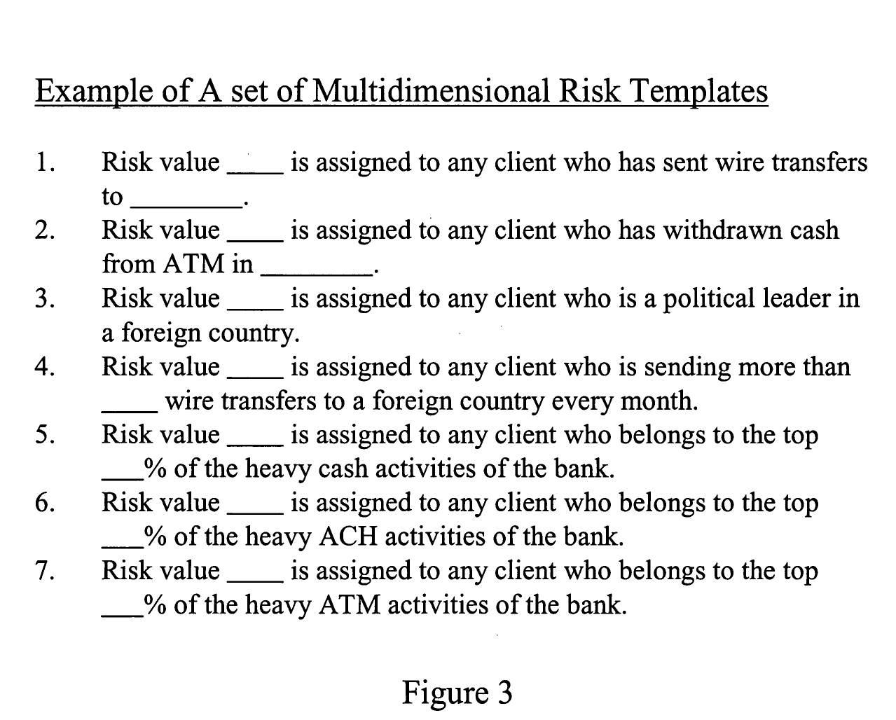

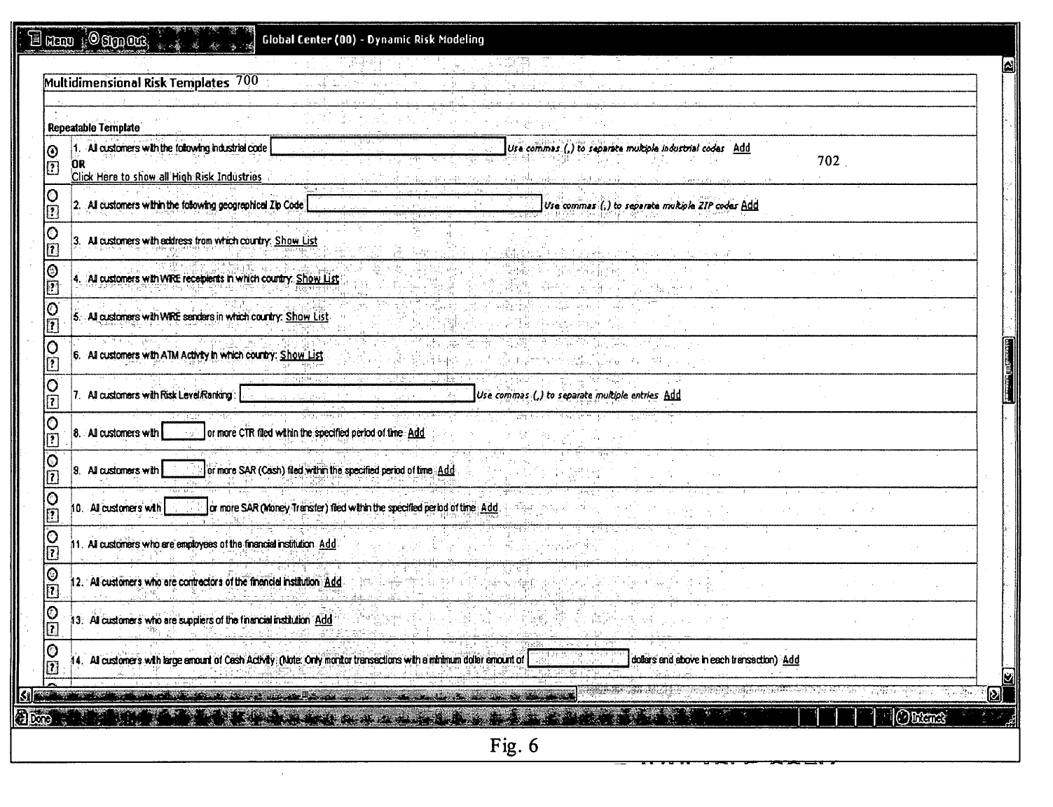

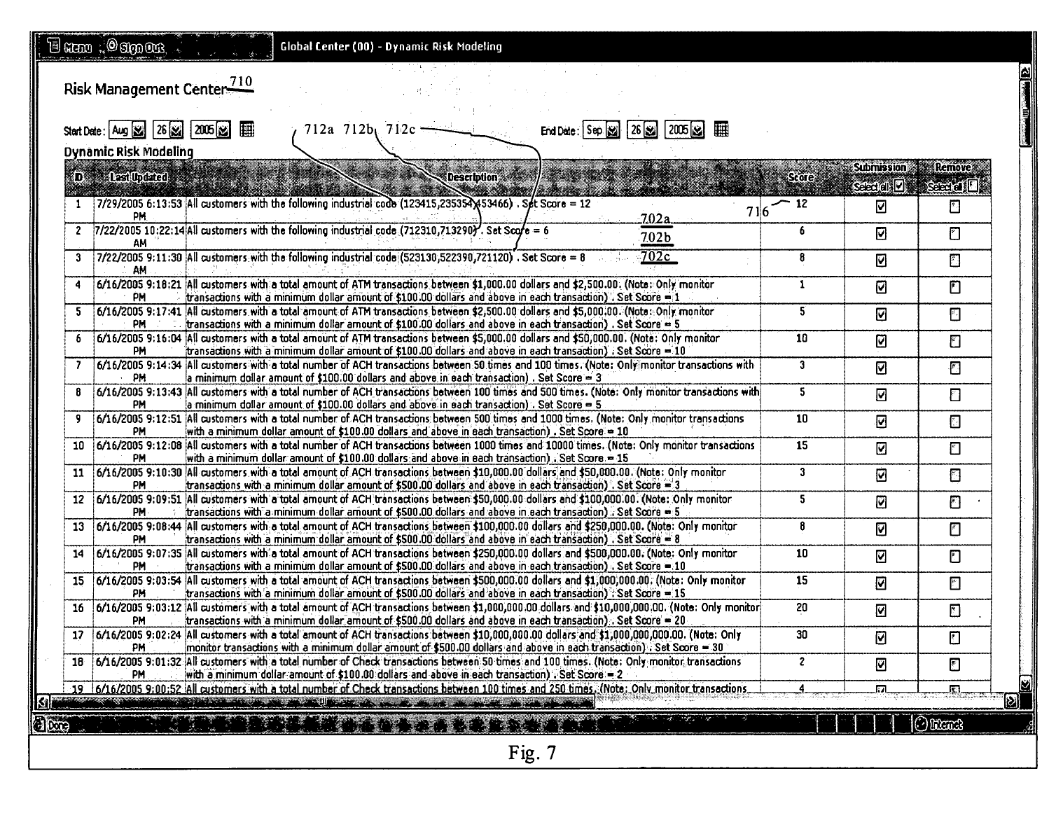

In general, risk dimensions include the possible transactional patterns, behavior patterns, historical patterns, natures, geographical locations, social status, business types, occupation types, identification codes, political relationships, foreign relationships, ownerships, the possible organizational structures of the subject, etc. A simple example of a set of Multidimensional Risk Templates is shown in FIG. 3. Reference should also be made to FIG. 6, which is an actual computer generated display 700 of a representative collection of Multidimensional Risk Templates 702, 704, which financial institutions may use in accordance with the requirements of the Bank Secrecy Act. Reference should also be made to the computer generated display 710 of FIG. 7 which shows how the Multidimensional Risk Templates of FIG. 6 may be copied (lines 702a, 702b, 702c) and different information 712a, 712b, 712c may be filled into blanks 714, and respective Scores 716 assigned by the involved financial institution.

Once all the risk dimensions are identified and each risk dimension is assigned a risk value, the result will be a set of multidimensional risk values for each of the subjects.

For example, a user may assign a risk value of 6 to those Subjects who send wire transfers to Iraq. The user can assign a risk value of 4 to those Subjects who are the top 5% of Subjects who conduct heavy cash transactions in the bank. The user can also assign a risk value of 5 to those Subjects who are conducting money services businesses. If a Subject, who conducts money services business, also often sends wire transfers to Iraq, and belongs to the top 5% of Subject who conduct heavy cash transactions, he would be assigned a set of risk values, which is (6,4,5).

In this example, only 3 risk dimensions have been defined and, consequently, there are only 3 risk values in the Definitions Set. However, in practice, there may be hundreds of risk dimensions. Obviously, a complete set of Multidimensional Risk Definitions may easily create a large number of risk values for each Subject in a bank. It can become very confusing and difficult for the bank to use these risk values.

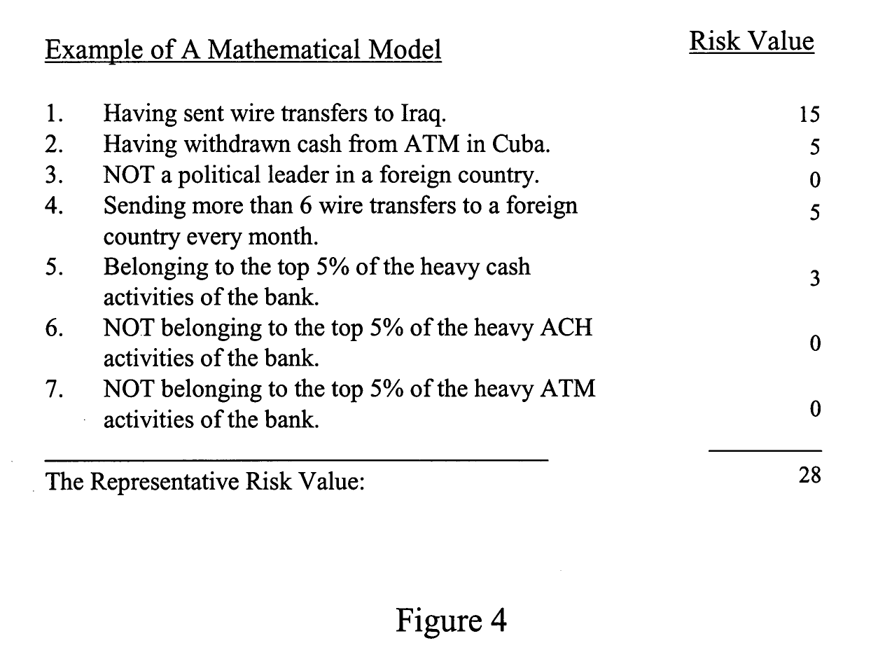

In one embodiment of the present invention, the user establishes a mathematical model (see FIG. 4), which transforms the set of multidimensional risk values of each subject into a simplified set of representative risk values (or preferably, as illustrated, a single representative risk value), which represent the overall risks of the subject.

A mathematical model can be established based on mathematical operators such as addition, subtraction, multiplication, division, polynomial function, fraction function, exponential function, logarithm function, trigonometric function, inverse trigonometric function, linear transformation, non-linear transformation, etc. A simple mathematical model is, for example, adding all the multidimensional risk values together. In this example, the set of representative risk values has only one value, which is the sum of all the multidimensional risk values. An example of a mathematical model based on summation is shown in FIG. 4, using the risk dimensions produced by the Multidimensional Risk Templates shown in FIG. 3.

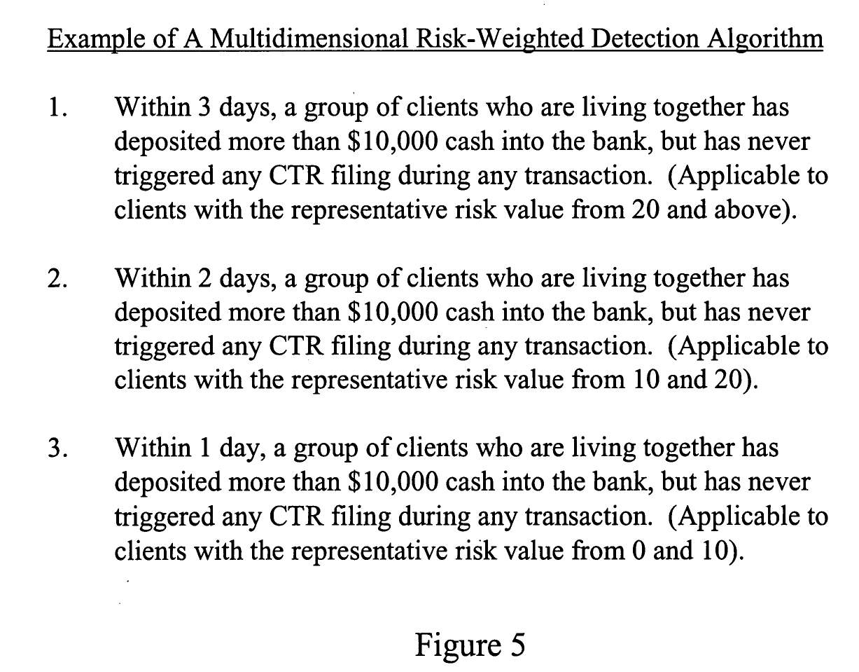

Then, in one embodiment of the present invention, the user establishes a set of detection algorithms, which have incorporated the representative risk values to increase the resolution of the detection and thus the accuracy of the detection result. Based on the representative risk values of each subject, a different set of detection algorithms may be applied to the subject. An example of a Multidimensional Risk-Weighted Detection Algorithm is shown in FIG. 5 based on the mathematical model shown in FIG. 4.

Once the detection results are produced, in one embodiment of the present invention, the detection results may be used as user feedback information to permit the use to refine the definition of the multidimensional risks and their values so that the future detection results will be more and more accurate.

In another embodiment of the present invention, the detection results may be used as user feedback information to permit the user to refine the mathematical model so that the future detection results will be more and more accurate.

In yet another embodiment of the present invention, the detection results are used as user feedback information to permit the user to refine the Multidimensional Risk-Weighted Detection Algorithms so that the future detection results will be more and more accurate.

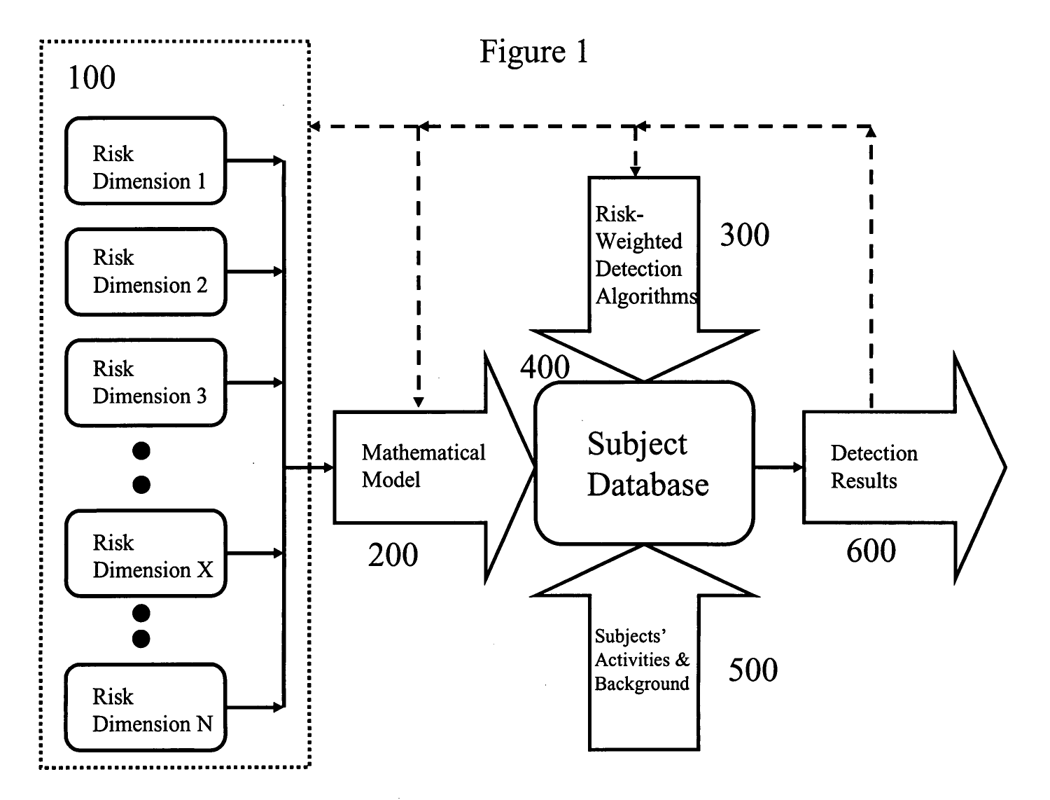

As contemplated in certain described embodiments, the present invention uses Multidimensional Risk-Weighted Detection Algorithms to detect suspicious and fraudulent activities among a group of subjects as shown in FIG. 1. The subjects' background and activities data 500 is input into a database 400.

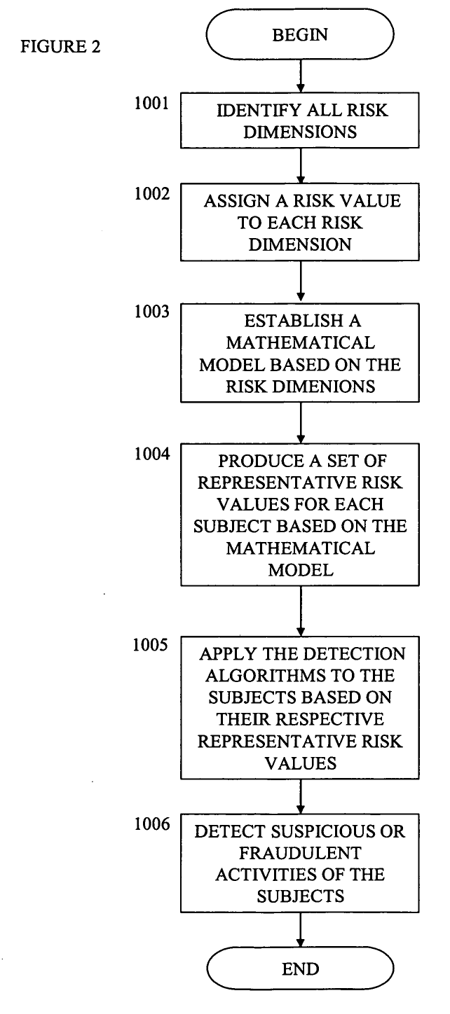

References should now be made to the flowchart of FIG. 2 in combination with the system diagram of FIG. 1, which together illustrate how the user can use this Dynamic Multidimensional Risk-Weighted Suspicious Activities Detector to detect suspicious and fraudulent activities with higher resolution and accuracy.

First, the user has to identify all the possible risk dimensions 100, which may be related to the data in the subject database 400 (block 1001).

Then (block 1002), the user has to assign a risk value to each of the risk dimensions.

The user establishes a mathematical model 200, which can transform multidimensional risk values 100 into a set of representative risk values (block 1003).

The user uses the mathematical model 200 to produce a set of representative risk values for each of the subject in the database and stores these representative risk values into the subject database 400 (block 1004).

The user establishes a set of Multidimensional Risk-Weighted Detection Algorithms 300 and uses these algorithms to run though the subject database 400 based on the representative risk values of each of the subjects (block 1005).

Subsequently (block 1006), these Multidimensional Risk-Weighted Detection Algorithms detect the suspicious or fraudulent activities of the subjects and produce the detection results 600.

The detection results can be used as the feedback information to further adjust the definition of the multidimensional risks and their values 100, the mathematical model 200, and the Multidimensional Risk-Weighted Detection Algorithms 300 so that the future detection results will become more and more accurate.

One example of such a mathematical model of a Representative Risk Value is the mathematical summation of the individual risk value associated with each Risk Dimension identified for that particular Subject. In the previous example, if a subject, who conducts money services business, also often sends wire transfers to Iraq, and belongs to the top 5% of subjects who conduct heavy cash transactions, he would be assigned a representative risk value of 15 (i.e., 6+4+5=15) based on a simple mathematical model, which has only one mathematical operator: addition.

Alternatively, “adding the multiple powers of each multidimensional risk value” could also be used as the mathematical model. For example, this subject may be assigned a representative risk of 77 using the power of 2 (i. e., 36+16+25=77). He can also be assigned a representative risk of 405 using the power of 3 (i. e., 216+64+125=405). Other methods such as the square root of the sum or the sum of the square roots can achieve similar purposes.

In principle, by combining multidimensional risks with all kinds of mathematical operators such as addition, subtraction, multiplication, division, polynomial function, fractional function, exponential function, logarithm function, trigonometric function, inverse trigonometric function, linear transformation, non-linear transformation, etc., there are many ways to establish a mathematical risk model which incorporates multiple risk dimensions.

No matter which risk model is used, these multidimensional risks can be integrated into a simplified set of representative risk values, which represent the overall risks associated with a subject. Establishing such a risk model is an important step in transforming multidimensional risks into a manageable format.

In other words, the compliance officer of a financial institution can use “Multidimensional Risk Templates” to create a set of Multidimensional Risk Definitions which in turn can be used by a computer to dynamically assign a set of risk values to each subject based on the current characteristics of the subject as reflected in the subject background and activities data in the computer's database. Then, risk modeling can be used to transform the resultant large number of risk values for each subject into a simplified set of representative risk values.

Since subjects change their activities from time to time, the computerized risk value assignment and modeling process is repeated “dynamically” to obtain a set of the most up-to-date representative risk values. For easy reference, we will refer to this dynamic risk modeling process as “Dynamic Risk Modeling.”

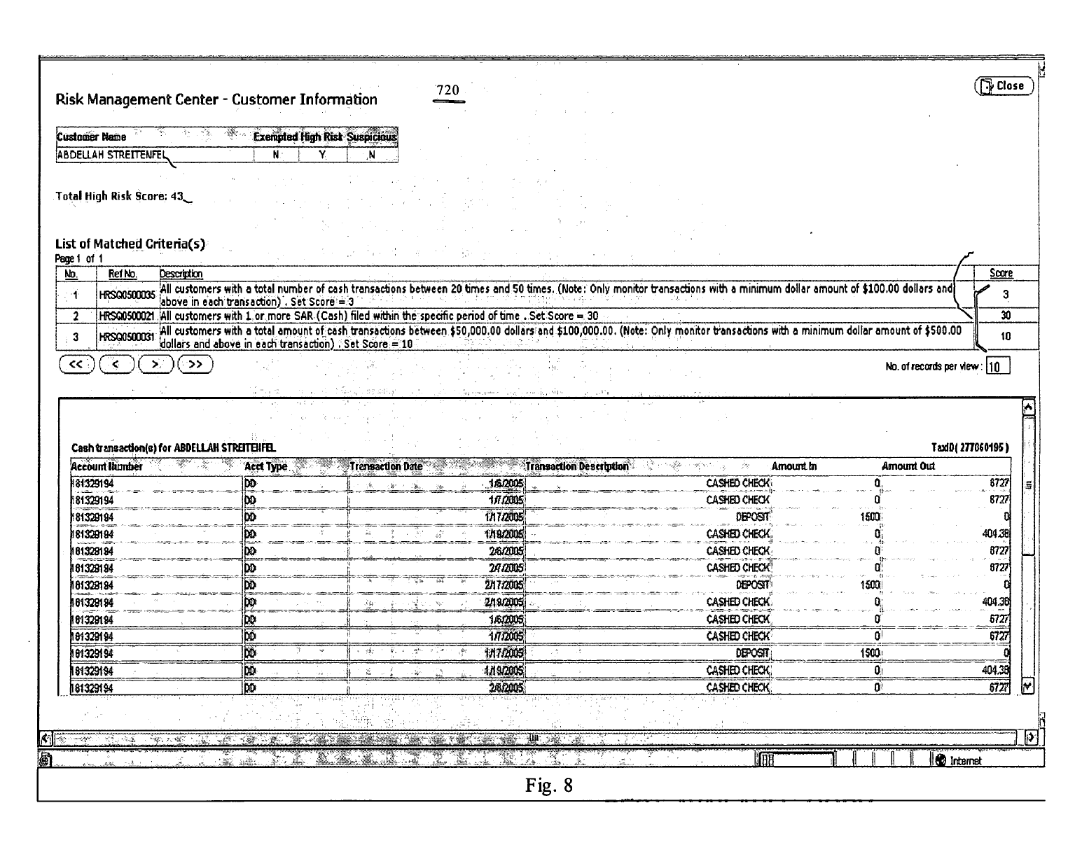

As shown in FIG. 8, which is an exemplary computer generated display 720 showing how Dynamic Risk Modeling was used to assign a representative risk value 722 to one customer 724 of a financial institution. On this screen, a person has matched three risk dimensions 726 with risk values of 3, 30, and 10, respectively. A representative risk value 722 of “43” is produced based on a mathematical model of summation. For verification purposes, the detailed information of matching the first risk dimension is listed. A user can click on other risk dimensions one by one to verify the details.

In one preferred embodiment, the output 722 from the Dynamic Risk Modeling (FIG. 8) is used to fine-tune the detections to detect suspicious activities

The simple mathematical summation of all multidimensional risk values is a readily understandable example of a method to establish a risk model which generates a single value to represent the multidimensional risks associated with each subject. Summation is the particular mathematical operator used in the mathematical model in the example of FIG. 8 to combine the component Scores 726 of the High Risk Profile 728 for one particular customer 724 into a Total High Risk Score 722.

It is usually very difficult to find the optimal point to establish a detection algorithm to detect suspicious activities. For example, the system may miss the necessary detections if the detection thresholds are set too tight. On the other hand, the system may make false detections if the detection thresholds are set too loose. Now, the output of the Dynamic Risk Modeling can help the system, for example, find the optimal set of thresholds.

In summary, as a result of using Multidimensional Risk Templates and Dynamic Risk Modeling, a set of the most up-to-date “representative values” have been created for each subject, which can be used to fine-tune the algorithms for detecting suspicious activities. These “risk-tuned” algorithms are thus examples of “Multidimensional Risk-Weighted Detection Algorithms.”

For example, it is possible to detect whether any subject has conducted too many cash transactions based on detecting any subject who has conducted more than 10 cash transactions per week.

In this example, the choice of the number 10 is very subjective and the system will miss whoever only conducts 9 or less cash transactions in a week. As a result, this kind of detection algorithms is not optimized.

The basic concern about this approach is whether the number 9 is really so very different from the number 10. When a subject conducts 9 transactions per week, the system will not detect it, while the system will detect it if the subject conducts just one more transaction in that week. Obviously, the number 10 may not be an optimal threshold for this detection.

By using the output from the Dynamic Risk Modeling, the current algorithm can be enhanced with a higher resolution by considering the overall risk involved. For example, assuming a representative risk value (i. e., overall risk) with a range from 0 to 200 as the output from the Dynamic Risk Modeling, the number 10 can be used as the threshold if the representative risk value is 80 or less; 9 if the representative risk value is between 80 and 100; 8 if the representative risk value is between 100 and 120; 7 if the representative risk value is between 120 and 140; and 6 if the representative risk value is 140 or more.

In this example, monitoring less than 6 cash transactions per week may not make much sense for business accounts because many businesses are conducting one cash transaction per day. To make the detection more precise, an extra criterion, such as “business accounts only,” may be used to improve the detection accuracy. Of course, a separate detection algorithm can be established for personal accounts.

In the above example, the multidimensional risks have been integrated into the detection algorithm to increase the resolution of the detection, and consequently enhance the accuracy of the detection result.

In addition to using the risk values as described above, detection algorithms can apply only to a specific group of subjects, who are exposed to a specific set of risks. For example, those particular money services businesses can be detected which have sent wire transfer to Iraq for more than $50,000 within 30 days.

In this example, conducting money services businesses is one risk dimension and sending wire transfer to Iraq is another risk dimension. Detecting a total transaction amount of more than $50,000 within 30 days is a detection algorithm, which is applied only to those subjects who have matched the aforementioned two risk dimensions.

Furthermore, risk dimensions can also be used to identify a specific group and perform group analyses in order to facilitate the making of more objective decisions.

For example, a car dealer has been identified which has a substantial increase in cash deposits, it may be useful to find out whether all the other car dealers have the same transactional patterns or not. If all the car dealers have a similar type of increase in cash deposits, it may just be the trend of the car dealer industry and there is nothing suspicious in this case.

In this example, only one risk dimension, car dealer, is used for explanation purposes. In reality, it may be necessary to deal with many different risk dimensions in order to be precise in the analyses. For example, car dealers in different geographical areas (i. e., different risk dimensions) may have different trends. Car dealers of different brands (i. e., different risk dimensions) may have different trends. This kind of analyses can become very complicated and difficult to perform.

With an exemplary embodiment of the present invention, a user can easily identify what risk dimensions a specific subject may contain. We may call this process a “multidimensional drill-down.” Then, through an exemplary embodiment of the present invention, all subjects can be identified that contain the same set of risk dimensions as this specific subject may contain.

Once this specific group of subjects has been identified, their group statistics can be obtained. By comparing the individual with the group statistics, it can then be determined whether the individual has any suspicious activity.

As a result, the described exemplary embodiments of the present invention can detect the suspicious and fraudulent activity of any subject based on Multidimensional Risk-Weighted Detection Algorithms with higher resolution to obtain more accurate detection results and with risk-oriented group comparison to draw more accurate conclusion.

All the suspicious activities associated with a particular subject, or a defined subset of those activities requiring further investigation, may be considered a single “case”. Since more than one case may be detected at the same time, it may be more convenient for the users to investigate these cases one by one based on a priority sequence.

In one embodiment of the present invention, the priority sequence for evaluating the individual cases is determined based on the set of representative risk values of the subject associated with each detected case.

For example, if the subject of a particular detected case of potentially suspicious activities has a set of representative risk values of (30,20,40), we can use a mathematical model to convert these values into a single value, which determine the priority of the case. In one embodiment of the present invention, a simple mathematical model is the summation of all these values. In this example, we have a value of 90 for this case. As a result, a user can investigate the cases one by one based on the relative sequence of these values.

In another embodiment of the present invention, the priority sequence is determined based on the set of detection algorithms that detect the subject and the associated suspicious activities. Each of the detection algorithms is assigned a “Priority Value” and a subject can be detected by multiple detection algorithms with multiple “Priority Values.”

For example, if a subject is associated with potentially suspicious activities that have been detected by detection algorithms with Priority Values of 1 and 5, we can use a mathematical model to covert these priority values into one single value, indicating the priority of this case. In one embodiment of the present invention, a simple mathematical model is the summation of all of these values. In this example, a value of 6 is produced to set the priority of the case during the investigation process.

In yet another embodiment of the present invention, these “Priority Values” of all the detection algorithms that detect the potentially suspicious activities associated with the subject are used together with the Representative Risk Value of the subject to form a decision vector, which is used to determine whether this subject's activities should be investigated at a higher priority than other subjects' activities.

For example, if a subject with a set of representative risk values of (30,20,40) has associated activities which have been detected by 2 detection algorithms with Priority Values of (1, 5), the decision vector for that subject is (30,20,40,1,5). To make a decision, we may have to convert this vector into a single value through a mathematical model so that this single value can determine how high the priority of the detected case is for investigation.

There are many ways to establish a mathematical model as we explained earlier. In one embodiment of the present invention, a simple mathematical model is to add all of these components of the decision vector together, which becomes 96 (i.e., 96=30+20+40+1+5).

Obviously, a simple summation may not work well in this case because the representatives risk values are much larger than the Priority Values of the detection algorithms. As a result, Priority Values practically have no effect or negligible effect in this decision. To fairly consider all the effects of all components of the decision vector, we may have to adjust the Priority Values to make them about the same magnitude of the representative risk values.

For example, if we adjust the Priority Values by 10 times, we will have (10,50), instead of (1, 5). As a result of this adjustment, the summation of these values becomes more meaningful and we will obtain a new value of 150 (i.e., 150=30+20+40+10+50). This kind of process to adjust the relative magnitude of the values to make the calculation results more meaningful is generally referred to as “normalization.” There are many different way to normalize these values. The ultimate goal is to obtain an objective and easy-to-use value that can determine which case has the higher priority than others for investigation.

In one embodiment of the present invention, all the representative risk values of the detected subject are added together to form one single representative risk value, and all the Priority Values of the detection algorithms that detect the subject are added together to form a single representative Priority Value. The single representative risk value and the single representative Priority Value are then normalized to the same range of magnitude. The square root of the summation of the square of each of these two normalized values may be used to determine the priority of the case.

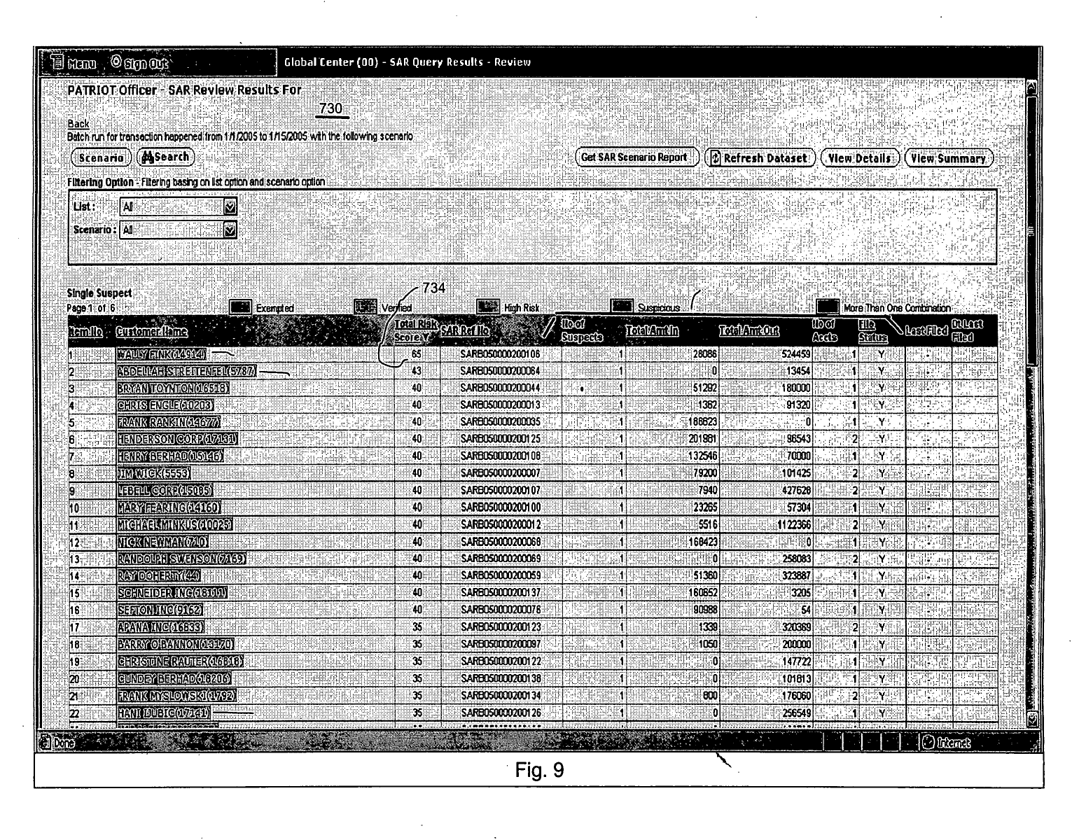

As shown in FIG. 9, which is an exemplary computer screen display used to generate a SAR Review Report 730, 22 cases 732a, 732b, *** 732c have been detected by the Dynamic Multidimensional Risk-Weighted Suspicious Activities Detector in accordance with the requirements of the Bank Secrecy Act. The representative risk value 734, which is obtained based on a mathematical model of summation, is used to determine the priority sequence of these cases during the investigation process. A user can investigate these cases one by one from top to bottom of the screen because these cases are sorted based on the magnitude of these representative risk values. A brief summary 736 is listed for each case. A user can click on any of these cases and a new window will pop out to display the details of that case.

Furthermore, as shown by the dashed arrows leading from block 600 to blocks 100, 200 and 300 of FIG. 1, the detection results can be used as the feedback information to adjust the Multidimensional Risk Templates, the Dynamic Risk Modeling, and the Risk-weighted Detection Algorithms. Such an “adaptive” process can help ensure that the future detection results will become more and more accurate.

Those skilled in the art will undoubtedly recognize that the described embodiments can be assembled in various ways to form a variety of applications based on the need, and that obvious alterations and changes in the described structure may be practiced without meaningfully departing from the principles, spirit and scope of this invention. Accordingly, such alterations and changes should not be construed as substantial deviations from the present invention as set forth in the appended claims.

1. A computer assisted method to facilitate the detection of suspicious and fraudulent activities in a group of subjects by:
storing activities and background data associated with each subject into a database;
defining multidimensional risks based on said activities and background data;
assigning a risk value to each of the multidimensional risks;
analyzing the database to determine a respective set of multidimensional risk values for each subject;
establishing a mathematical model which reduces each set of multidimensional risk values to one or more representative risk values which represent the overall risks of the respective subject;
applying the mathematical model to each said set of multidimensional risk values to thereby produce a set of representative risk values for each subject,
establishing a set of multidimensional risk-weighted detection algorithms that include said representative risk values;
using the representative risk values for each subject to select a respective subset of said multidimensional risk-weighted detection algorithms applicable to that particular subject; and
identifying potentially suspicious or fraudulent activities by using said respective subset of said multidimensional risk-weighted detection algorithms to analyze and detect suspicious or fraudulent activities associated with said particular subject.

2. The method of claim 1 wherein:
the analyzing database to determine a respective set of multidimensional risk values for each subject and applying mathematical model to each said set of multidimensional risk values to thereby produce a set of representative risk values for each subject steps are repeated to thereby dynamically update said respective risk values prior to performing the identifying step on more recent activities.

3. The method of claim 1 wherein: the multidimensional risks include at least the possible transactional patterns of the subjects.

4. The method of claim 1 wherein:
the multidimensional risks include at least the possible behavior patterns of the subjects.

5. The method of claim 1 wherein:
the multidimensional risks include at least the possible historical patterns of the subjects.

6. The method of claim 1 wherein:
the multidimensional risks include at least the possible natures of the subjects.

7. The method of claim 1 wherein:
the multidimensional risks include at least the possible geographical locations of the subjects.

8. The method of claim 1 wherein:
the multidimensional risks include at least the possible social status of the subjects.

9. The method of claim 1 wherein:
the multidimensional risks include at least the possible business types of the subjects.

10. The method of claim 1 wherein:
the multidimensional risks include at least the possible occupation types of the subjects.

11. The method of claim 1 wherein:
the multidimensional risks include at least the possible identification codes of the subjects.

12. The method of claim 1 wherein:
the multidimensional risks include at least the possible political relationships of the subjects.

13. The method of claim 1 wherein:
the multidimensional risks include at least the possible foreign activities of the subjects.

14. The method of claim 1 wherein:
the multidimensional risks include at least the possible ownership categories of the subjects.

15. The method of claim 1 wherein:
the multidimensional risks include at least the possible organizational structures of the subjects.

16. The method of claim 1 wherein:
the mathematical model at least involves addition of two or more risk values.

17. The method of claim 1 wherein:
the mathematical model at least involves subtraction of a first risk value from a second risk value.

18. The method of claim 1 wherein:
the mathematical model at least involves multiplication of a first risk value by a second risk value.

19. The method of claim 1 wherein:
the mathematical model at least involves division of a first risk value by a second risk value.

20. The method of claim 1 wherein:
the mathematical model at least involves a polynomial function.

21. The method of claim 1 wherein:
the mathematical model at least involves an exponential function.

22. The method of claim 1 wherein:
the mathematical model at least involves a logarithm function.

23. The method of claim 1 wherein:
the mathematical model at least involves a trigonometric function.

24. The method of claim 1 wherein:
the mathematical model at least involves an inverse trigonometric function.

25. The method of claim 1 wherein:
the mathematical model at least involves a linear transformation.

26. The method of claim 1 wherein:
the mathematical model at least involves a non-linear transformation.

27. The method of claim 1 wherein:
the set of representative values includes at least a single value.

28. The method of claim 1 further comprising:
the set of representative risk values of a subject is produced from the mathematical model based on the set of multidimensional risk values of the subject dynamically so that this set of representative risk values precisely represents the most up-to-date characteristics of the possibly evolving activities or background of the subject.

29. The method of claim 1 further comprising:
adjusting the definitions of the multidimensional risks and their values manually based on the feedback from the detection results of suspicious or fraudulent activities.

30. The method of claim 1 further comprising:
adjusting the definitions of the multidimensional risks and their values automatically based on the feedback from the detection results of suspicious or fraudulent activities.

31. The method of claim 1 further comprising:
adjusting the mathematical model manually based on the feedback from the detection results of suspicious or fraudulent activities.

32. The method of claim 1 further comprising:
adjusting the mathematical model automatically based on the feedback from the detection results of suspicious or fraudulent activities.

33. The method of claim 1 further comprising:
adjusting the multidimensional risk-weighted detection algorithms manually based on the feedback from the detection results of suspicious or fraudulent activities.

34. The method of claim 1 further comprising:
adjusting the multidimensional risk-weighted detection algorithms automatically based on the feedback from the detection results of suspicious or fraudulent activities.

35. A computerized method to define a comprehensive set of multidimensional risks and their values, and to assign a set of risk values to each of the subjects in a database, by
identifying all the possible different risk dimensions associated with the group of subjects based on the activities and background of these subjects;
grouping a similar type of risk dimensions into the same risk category;
using the same definition to describe the common part of all risk dimensions in the same risk category but including at least one variable so that a “multidimensional risk template” is produced for this particular risk category;
producing a separate “multidimensional risk template” for each risk category;
permitting the user to enter a different value for each variable into multiple copies of the same “multidimensional risk template” to complete the definition of multiple risk dimensions within the same risk category;
saving the defined risk dimensions and their associated risk values into the database;
using the definition of a risk dimension and its risk value to produce a database program, which will assign the said risk value to any subject in the database that has a risk exposure matching the definition of the risk dimension; and
repeating the preceding step for each of the risk dimensions until the entire set of multidimensional risks and their values have been assigned to all the subjects in the database.

36. The method of claim 35 further comprising:
choosing any of the risk dimensions and identifying all the subjects that contain such a risk dimension so that analyses can be performed for this specific group of subjects that contain such a risk.

37. The method of claim 36 further comprising:
choosing any individual subject and identifying a specific group of subjects that contain a specific risk dimension as the individual subject; and
comparing the patterns of such an individual subject with the statistical patterns of such a group to identify possible suspicious and fraudulent activities of such an individual subject.

38. The method of claim 35 further comprising:
choosing any set of the risk dimensions and identifying all the subjects that contain such a set of risk dimensions so that analyses can be performed for this specific group of subjects that contain such a set of risks.

39. The method of claim 38 further comprising:
choosing any individual subject and identifying a specific group of subjects that contain a specific set of risk dimensions as the individual subject; and
comparing the patterns of such an individual subject with the statistical patterns of such a group to identify possible suspicious and fraudulent activities of such an individual subject.

40. A computer assisted method to facilitate the detection of suspicious and fraudulent activities in a group of subjects by:
storing activities and background data associated with each subject into a database;
defining multidimensional risks based on said activities and background data;
assigning a risk value to each of the multidimensional risks;
analyzing the database to determine a respective set of multidimensional risk values for each subject;
establishing a mathematical model which reduces each set of multidimensional risk values to one or more representative risk values which represent the overall risks of the respective subject;
applying the mathematical model to each said set of multidimensional risk values to thereby produce a set of representative risk values for each subject,
establishing a set of multidimensional risk-weighted detection algorithms that can be selected based on the multidimensional risks;
using the multidimensional risks of each subject to select a respective subset of said multidimensional risk-weighted detection algorithms applicable to that particular subject; and
identifying potentially suspicious or fraudulent activities by using said respective subset of said multidimensional risk-weighted detection algorithms to analyze and detect suspicious or fraudulent activities associated with said particular subject.

41. A computerized method to dynamically produce a set of representative risk values for each of the subjects in a database by:
defining a comprehensive set of multidimensional risks and their values based on the activities and background of the subjects;
assigning the set of risk values to each of the subjects based on the characteristics of the subject;
establishing a mathematical model based on the set of multidimensional risks;
using the mathematical model to produce a set of representative risk values for each subject in the database; and
repeating the assigning risk values and using mathematical model steps dynamically so that the set of representative risk values of each subject represents the updated overall risks of each of the subjects in the database.

42. A computerized method to establish the priority of investigating cases of suspicious activities, which are detected by Multidimensional Risk-Weighted Detections, for a group of subjects in a database by
identifying a set of representative risk values that represent the overall risks for each of the subjects based on the multidimensional risks;
identifying all the possible detection algorithms based on the purpose of the system;
assigning a priority value to each of the detection algorithms,
combining the priority values of those detection algorithms that jointly detect a subject with the representative risk values of said detected subject to form a decision vector; and
determining whether said detected case should be investigated with higher priority based on the characteristics of this decision vector.

43. The method of claim 42 wherein:
the characteristics of the decision vector are measured at least through a mathematical transformation of the decision vector.

44. The method of claim 43 wherein:
the mathematical transformation includes at least the proportional adjustment of the value of each component of the vector to make the maximum value of each component of the vector about the same magnitude (a “normalization” process to “normalize” a vector).

45. The method of claim 43 wherein:
the mathematical transformation includes at least the root square of the summation of the square of each component of the normalized vector.

46. The method of claim 43 wherein:
the mathematical transformation includes at least the summation of the square of each component of the normalized vector.

47. The method of claim 43 wherein:
the mathematical transformation includes at least the summation of the components of the normalized vector.

48. The method of claim 43 wherein:
the mathematical transformation includes at least the summation of the components of the decision vector.

49. The method of claim 43 wherein:
the mathematical transformation includes at least the combining of the components of the decision vector into a single value through a mathematical model.

50. The method of claim 43 wherein:
the mathematical transformation includes at least the combining of the components of the normalized decision vector into a single value through a mathematical model.
